(19) United States
(12) Patent Application Publication
(10) Pub. No.: US 2017/0282401 A1
(43) Pub. Date: Oct. 5, 2017

(54) Casting Cores And Producing Slips

(71) Applicant: Siemens Aktiengesellschaft, Muenchen (DE)

(72) Inventors: Hermann Boedinger, Muenchen (DE); Stefan Denneler, Muenchen (DE); Carsten Schuh, Baldham (DE); Matthias Uebler, Ursensollen (DE)

(73) Assignee: Siemens Aktiengesellschaft, Muenchen (DE)

(21) Appl. No.: 15/513,759

(22) PCT Filed: Sep. 18, 2015
(86) PCT No.: PCT/EP2015/071476

§ 371 Date: Mar. 23, 2017

(30) Foreign Application Priority Data
Sep. 26, 2014 (DE) 10 2014 219 543.8

(51) Int. Cl. B28B 1/26; B28B 1/00; B22F 3/22

(52) U.S. Cl. CPC B28B 1/264; B22F 3/227; B28B 1/266; B28B 1/004; B28B 1/267; B28B 1/081

(57) ABSTRACT

The present disclosure relates to casting cores. The teachings thereof may be embodied in methods for producing a slip and components produced using such methods. For example, a method for producing a slip may include: mixing at least one inorganic constituent with at least one binder, wherein the binder comprises at least one epoxy resin and at least one silicone copolymer.

### CROSS-REFERENCE TO RELATED APPLICATIONS

This application is a U.S. National Stage Application of International Application No. PCT/EP2015/071476 filed Sep. 18, 2015, which designates the United States of America, and claims priority to DE Application No. 10 2014 219 543.8 filed Sep. 26, 2014, the contents of which are hereby incorporated by reference in their entirety.

### TECHNICAL FIELD

The present disclosure relates to casting cores. The teachings thereof may be embodied in methods for producing a slip and components produced using such methods.

### BACKGROUND

In a typical precision metal casting process, e.g., lost negative molds, ceramic casting cores serve for construction of complex positive geometries, particularly in the representation of microscale-sized surface structures which cannot be produced by conventional milling or machining forms because of undercuts, cavities, or tooling-related resolution limits. The process is often used for cost-effective production of complex metal blades in gas turbines and propulsion turbines.

To produce lost casting cores, the slip technique includes dispersing a high-temperature-sinterable powder conglomerate composed of different kinds of inorganic constituents in a solvent with two types of binder which build on one another. This slip is poured into a casting mold for subsequent hardening. The casting mold bears the desired architectural and surface structuring which the ceramic casting core is intended to adopt in its later state. Through application of reduced pressure and vibration, the solvent, which serves primarily for reducing viscosity, is stripped off, and at the same time the filler powder fraction is sedimented off and compacted in accordance with the maximum packing density of the powder particle size distribution.

By warm or hot hardening at up to 160° C., the first binder or binder constituent undergoes polymerization, thus giving the resulting green compact the geometry which is to be fixed by sintering later on. Next, this green compact is freed from the casting mold and then sintered in a stepwise temperature profile to form the ceramic. At up to 300° C., the first binder constituent undergoes pyrolysis and is largely expelled in the form of gaseous oxidation products. To preserve the shape and architecture of the debindered green compact, called a “brown compact”, ahead of the final sintering at high temperatures, a second, high-temperature-resistant binder or binder constituent is commonly used which ensures the shape after debinding. At from about 250° C. to about 500° C., this constituent undergoes solidification, giving off volatile constituents in so doing. In a final temperature step, high-temperature sintering of the brown compact produces the ceramic, which later serves for precision metal casting.

US 2011018944 A1 discloses an overall binder system comprising a combination of anhydridically thermosetting, cycloaliphatic epoxy resin and reactive, methylpolysiloxane-based silicone solid. With addition of dispersion additives, plastifiers (rubber), and solvents (methyl ethyl ketone, isopropyl alcohol or hexane), a slip formulation can be provided which has a high fraction of sintered ceramic powder and is fit for the casting of lost ceramic green cores. The sintered ceramic powder is a multimodal, packing density-optimized mixture composed of amorphous fused silica, cristobalite, magnesium oxide, aluminum oxide, yttrium oxide, and zirconium oxide. Cycloaliphatic epoxy resins are notable for particularly low dynamic viscosities, allowing required solvent contents to be lower. The hardener component of the epoxy resins is commonly an acid anhydride, of the methylhexahydrophthalic acid, methyltetrahydrophthalic acid or methylnadic acid type, for example. These mixtures constitute high-temperature systems which require an accelerator to initiate the polymerization and necessitate hardening temperatures of more than 130° C. over several hours. The reaction shrinkage in US 2011018944 is in the region of up to 5 vol %.

US 2011018944 discloses a second binder for forming the brown compact state made of reactive silicone solid in the form of a polycondensation-crosslinking alkoxyorganopolysiloxane which, under temperature exposure, undergoes pyrolysis to form amorphous quartz. This silicone solid is admixed in the form of a loose powder additive fraction to the sintered ceramic powder.

### SUMMARY

To further lower the hardening temperatures with existing formulations, it is not possible to ensure complete polymerization of the admixed silicone powder. Vulcanization of the silicone powder below 100° C. to a stiff silicone binder system for fixing the sintered ceramic powder is not adequate based on the underlying chemical mechanism (hydrolysis of ethoxy groups with subsequent condensation to form a silicone high polymer), since the hydrolysis requires accelerator substances and/or elevated temperatures. This results in reduced stiffness and/or in a low modulus of elasticity on the part of the green compact, impeding the utility for multiwall ceramic casting cores, for example.

The teachings of the present disclosure may enable a slip based on ceramic powder, which can be reliably stabilized mechanically at particularly low hardening temperatures, even as a brown compact. In some embodiments, at least one inorganic constituent is mixed with at least one first binder and the first binder comprises a mixture of at least one epoxy resin and at least one hardener for the at least one epoxy resin. The teachings may be applied in particular to more cost-effective production of complex metal blades in gas turbines and propulsion turbines of all kinds.

Some embodiments may include methods (S1, S1a, S1b, S1c) for producing a slip, wherein at least one inorganic constituent is mixed with at least one binder and the binder comprises at least one epoxy resin and at least one silicone copolymer.

In some embodiments, said silicone copolymer used comprises (Sic) at least one glycidyl-functional poly(phenyl-methyl)silicone.

In some embodiments, said silicone copolymer used comprises (Sic) at least one amino-functional poly(phenyl-methyl)silicone.

In some embodiments, said at least one silicone copolymer is blended with bisphenol A diglycidyl ether and/or bispenol F diglycidyl ether, more particularly in a 10% to 50% (w/w) blend.

In some embodiments, the binder comprises at least one amine as additional hardener.

In some embodiments, said additional hardener used comprises at least one amine organo-substituted in beta position.

In some embodiments, the additional hardener comprises polyetheramine.

In some embodiments, the at least one epoxy resin comprises (Sib) BADGE, BFDGE and/or a blend thereof.

In some embodiments, the binder has been or is admixed (Sib) with at least one epoxidic reactive diluent.

In some embodiments, the binder has been or is admixed with propylene carbonate, butylene carbonate, glycerol carbonate or at least one arbitrary mixture thereof.

In some embodiments, the slip has been or is admixed (S1) with methyl ethyl ketone, acetone and/or isopropanol as solvent.

In some embodiments, the at least one inorganic constituent comprises (S1a) different fractions, more particularly ceramic powder fractions, having particle size distributions bimodal or multimodal to one another.

In some embodiments, the slip comprises colloidally disperse, amorphous silicon dioxide nanoparticles, more particularly when a surface of the silicon dioxide nanoparticles has been covalently coated (S1c) with an epoxide-compatible adhesion promoter.

Some embodiments may include components produced by means of a slip, said slip having been produced by means of the method (S1, S1a, S1b, S1c) as described above.

### BRIEF DESCRIPTION OF THE DRAWINGS

The properties, features, and advantages of these teachings, as described above, and also the manner in which they are achieved, will become clearer and more readily understood in association with the following schematic description of a working example which is elucidated in more detail in association with a drawing. For greater ease of comprehension, elements in the drawing that are the same or whose effect is the same may carry identical reference symbols.

FIG. 1 shows an example embodiment of the production of a ceramic casting core in accordance with the teachings of the present disclosure.

### DETAILED DESCRIPTION

Some embodiments include methods for producing a slip, wherein at least one inorganic constituent is mixed with at least one binder and the binder comprises at least one epoxy resin and at least one silicone copolymer. On the basis of the binder thus constituted, the slip improves the complete incorporation of the brown-compact silicone component. It requires only very low (solidification) temperatures for its solidification and nevertheless features a processing time sufficiently long for producing a body by means of the slip. Slip processing times of several hours, for example, are achievable. The binder does not require any accelerator substances to initiate hardening. By means of this first binder, moreover, complete hardening can be achieved at this low temperature, enabling flexural strengths and breaking strengths to be provided that are appropriate for a further-processing operating chain.

Slips produced with these types of silicone require no further admixing of pulverulent silicone, since optimum dispersion takes place as a result of the chemical incorporation during the hardening reaction. Moreover, there is no separation during hardening. The binder can be provided with a low viscosity, thereby facilitating the shaping of the slip in a casting mold. This binder can be mixed with common solvents without undergoing decomposition, with mixing possible in any proportion. The binder performs addition-crosslinking hardening of the slip in a manner virtually free from reaction shrinkage, to form a stable molding.

The teachings herein may achieve solidification temperatures of not more than 70° C., more particularly of not more than 60° C., more particularly of not more than 50° C., more particularly of not more than 45° C., more particularly of not more than 40° C., more particularly of not more than 35° C., more particularly of less than 35° C. This allows alternatingly applied wax templates to be used for multiwall geometries that are to be realized, and/or allows wax casting molds to be used. The property of low-temperature solidification, especially hardening, allows the construction of multiwall casting cores through use of alternatingly applied template wax layers and slip layers.

The methods may be used if the first binder undergoes polymerization to form the molding at below the wax melting point. The melting point of common waxes is typically 50° C. to 70° C. Binders presently in use, in contrast, require solidification temperatures beyond the wax melting point for complete hardening, meaning that a multilayer design is not possible with these conventional binders.

The slip, however, can also be poured into any casting molds, such as into silicone molds, for example, and so on. In that case, the low hardening temperature allows an energy saving, particularly simple production, and prevents softening or even damage to the casting mold.

The at least one epoxy resin may be an epoxy resin or a mixture of two or more epoxy resins. Generally speaking, an epoxy resin may also be understood to comprise a parent monomer or oligomer. Thus, for example, “bisphenol A diglycidyl ether” or “bisphenol A diglycidyl ether resin” may be understood as not only the epoxy resin but also the parent monomer and/or oligomer.

The binder may be present in the form of a binder matrix, comprising as filler the at least one inorganic constituent), e.g., powder).

The silicone copolymer may comprise a short-chain silicone copolymer. The silicone copolymer may act as hardener. In some embodiments, said silicone copolymer comprises at least one glycidyl-functional poly(phenyl-methyl)silicone. It can be extended arbitrarily with epoxy resins and/or with the associated monomers and/or oligomers. It may also be extended using amines, which are described in more detail later on below. This substance acts as a cofunctional hybrid substance or hybrid polymer, which not only acts as a monomer or oligomer for producing epoxy resin(s) but also as a hardener for epoxy resin. The glycidyl-functional poly(phenyl-methyl)silicone is, in particular, a copolymer which is partially saturated with reactive groups in relation to the epoxy resin hardening reaction. Commercially available representatives are, for example, HP-1250 (Wacker Silikone) and Tego Albiflex 348 (Evonik Industries).

In some embodiments, said silicone copolymer comprises at least one amino-functional poly(phenyl-methyl) silicone. The amino-functional poly(phenyl-methyl)silicone acts more strongly as an aminic hardener. This substance as well may be a copolymer saturated partially with reactive groups in relation to the epoxy resin hardening reaction. Commercially available representatives of the amino-functional silicone types are, for instance, the derivatives HP-2000 and HP-2020 from Wacker Silikone.

For hard and stiff green compacts at low hardening temperatures of around 35° C. and suitable pot lives, binder may comprise a blend of amino-functional poly(phenyl-methyl)silicone with epoxy resin. For this purpose, the at least one silicone copolymer may be blended with bisphenol A diglycidyl ether and/or bisphenol F diglycidyl ether, more particularly in a 10% to 50% (w/w) blend. In this way, a high glass transition range is acquired after hardening at 35° C.

Generally speaking, at least one epoxy resin and at least one silicone copolymer may be blended or be present as a mixture. Additionally or alternatively, at least one epoxy resin and at least one silicone copolymer may be present as a hybrid or as a hybrid polymer. This may simplify handling. A silicone copolymer of this kind may be mixed with at least one epoxy resin and/or at least one further silicone copolymer.

In some embodiments, the binder comprises at least one amine as additional hardener. In some embodiments, the additional hardener comprises at least one amine sterically hindered in beta position.

In contrast, amines without steric hindrance, in combination with epoxy resins, have a pot life at room temperature of just a few minutes, a reason for their use as two-part instant adhesives. Given that the filling, degassing, and vibrating of the filled casting mold for the processing of slip formulations takes about an hour, however, this unhindered resin species may be unfit for the purpose stated.

Conversely, amines organo-substituted in beta position exhibit a significantly extended gel time in reaction with 1,2-oxirane units, such as, for example, bisphenol A diglycidyl ether resins (also referred to hereinafter as “BADGE”) or bisphenol F diglycidyl ether resins (also referred to hereinafter as “BADGE”). In some embodiments, said at least one sterically hindered amine comprises at least one amine organo-substituted in beta position. Such amines support the above advantages with a low technical production cost and complexity and are inexpensive to acquire. Through steric hindrance by means of organic groups such as methyl, ethyl, propyl and/or higher in beta position to the terminal amine, the reactivity of the terminal amino group can be reduced significantly in relation to 1,2-epoxide reactants, hence allowing the processing time to be extended.

In some embodiments, the at least one sterically hindered amine is or comprises at least one sterically hindered diamine. The use of diamines has effects, among others, of particularly advantageous dynamic viscosity values. A diamine sterically hindered by a methyl group is known, for example, under the tradename “Jeffamine D-230” from the company “Huntsman Corporation”.

Because short amines (including short diamines) in combination with 1,2-epoxy resins lead to relatively brittle molding materials, on account of the high network density developed, a certain flexibility in the high-polymeric network may reduce or prevent crack initiation and crack propagation. Polyethylene glycols having repeating units in the range from 3 to 20 can be used as additives for this purpose in epoxy resins. If segments with this kind of flexibility are present as spacers in the sterically hindered diamine, polyglycols with terminal hydroxyl groups act catalytically on the initiation of polymerization. In some embodiments, therefore, the hardener or the first binder is additionally admixed with polyethylene glycol having repeating units of between 3 and 20, more particularly having repeating units of between 3 and 20.

Structures of the additional hardener used therefore comprise polyethermethyldiamines. In some embodiments, the hardener or the first binder comprises polyethermethyldiamine(s) (also referred to hereinafter as “PEMDA”). In some embodiments, the additional hardener to comprise polyethermethyldiamine(s) of type

H₂N—CH(—CH₃)—CH₂—[O—CH₂—CH(—CH₃)]ₓ—NH₂ (I)

where x is a repeating unit of 0 to 40, more particularly of 2 to 35, more particularly of 2 to 34. The dynamic viscosities of the compound(s) (I) having a repeating unit number x of 2 to 3 is approximately 10 mPas at 25° C. and is consequently approximately ten times lower than the dynamic viscosity of the highly mobile methyltetrahydrophthalic anhydride that is often used in thermosetting systems.

Cycloaliphatic epoxy resins having very low viscosities often conform to the type of 3,4-epoxycyclohexylmethyl 3′,4′-epoxycyclohexanecarboxylate (“cycloaliphatic”). In some embodiments, the additional hardener (I) provides an extremely highly mobile binder matrix. The reactivity of the hindered polyethermethyldiamines relative to the 3,4-epoxycyclohexylmethyl 3′,4′-epoxycyclohexanecarboxylate, however, is so low that no gelling and/or reaction occurs even at elevated temperatures and on addition of accelerator in high percentage concentrations. At the same time, however, bisphenol A diglycidyl ether resins (BADGE) or bisphenol F diglycidyl ether resins (BFDGE) exhibit dynamic viscosities in the 4000-12 000 mPas range at room temperature, and so mixtures of this kind are relatively viscous. Distilled bisphenol F diglycidyl ether resins having dynamic viscosities in the 1200 to 1400 mPas range at room temperature are available commercially, but they may be relatively expensive and tend toward rapid crystallization; for formulation, this makes it necessary to carry out preheating or even continual hot holding, which may lead in turn to curtailment of pot lives.

In some embodiments, the epoxy resin(s) used comprise, for example, epoxy resin(s) based on BADGE, BFDGE and/or cycloaliphatic epoxy resins having terminal 1,2-oxirane units (including any desired mixtures thereof), which are available, for example, from Huntsman under the tradename “Araldite PY 306”, “CY 184” or “CY 192” or from Momentive under the tradenames “EPR158” or “EPR162”.

In some embodiments, the at least one epoxy resin comprises at least one bisphenol A/bisphenol F diglycidyl ether blend (“BADGE/BFDGE”), and/or the at least one epoxy resin comprises at least one BADGE/BFDGE blend, since such a blend does not exhibit any tendency toward crystallization.

In some embodiments, the binder is or has been admixed with at least one reactive diluent (also referred to hereinafter as “RD”), e.g., with at least one epoxidic reactive diluent. The at least one reactive diluent may improve the dynamic viscosity of the first binder. Correspondingly, preformulated products are available, for example, from Huntsman Corporation under the tradename “Araldite LY 1564”, “Araldite LY 1568”, “Araldite GY 793”, or “Araldite GY 794”.

In some embodiments, the epoxidic reactive diluent is a mono-, di- and/or even more highly functional epoxidic reactive diluent. Examples of reactive diluents which may be used are 1,4-butanediol diglycidyl ether, 1,6-hexanediol diglycidyl ether, neopentyl diglycidyl ether, cresyl glycide, or the like.

In some embodiments, the binder is admixed with propylene carbonate, butylene carbonate, glycerol carbonate or at least one arbitrary mixture thereof, or the binder comprises propylene carbonate, butylene carbonate, glycerol carbonate, or at least one arbitrary mixture thereof. The compositions including silicone copolymer hardeners are soluble without decomposition in the solvents methyl ethyl ketone, acetone, and isopropyl alcohol. In some embodiments, therefore, the slip comprises and/or is admixed with methyl ethyl ketone, acetone, and/or isopropanol as solvent.

The at least one inorganic constituent may comprise at least one powder or may comprise an inorganic powder constituent. The at least one inorganic constituent may comprise at least one ceramic powder, including a sinterable ceramic powder, e.g., magnesium oxide, aluminum oxide, yttrium oxide, and/or zirconium oxide. In addition to the at least one ceramic powder, the inorganic constituent may comprise at least one inorganic, nonceramic powder, e.g., amorphous fused silica and/or cristobalite. A green compact or green body can be formed from an at least partly ceramic powder. The at least one powder may be in dispersion in the first binder.

A green compact density is determined substantially by a maximum packing density of the ceramic powder, more particularly of the dispersed ceramic powder, so some embodiments include a maximum theoretical packing coefficient as high as possible. Through adjustment of multimodalities within the filler fraction, the packing density to be increased. For instance, the packing of a monodisperse powder with a Gaussian distribution around a defined particle diameter is approximately 64 vol %. By means of (“bimodal”) addition of at least one further powder fraction, whose particle diameter is selected such that the interspaces or interstices of the relatively coarse powder particles are partially filled by the smaller powder particles, packing densities of up to 80 vol % result. A trimodal powder mixture allows even higher packing densities of up to 90 vol %. Multimodal filler fractions are often employed as sintering powders, since in this way, contacts between adjacent powder particles are generated sufficiently, leading to a sintered ceramic of particularly low pore content. In some embodiments, therefore, the at least one inorganic constituent comprises different fractions, more particularly powder fractions, more particularly ceramic powder fractions, having particle size distributions that are multimodal (bimodal, trimodal, etc.) to one another.

The maximum packing coefficient of the slip or of a body (more particularly a green compact, a brown compact, or a fully sintered body) produced therefrom can be increased by incorporation or introduction of inorganic nanoparticles into the slip or as a constituent of the slip. The inorganic nanoparticles may migrate into the interspaces or interstices even of multimodal powder mixtures. Since inorganic nanoparticles are often present in powder form, with a tendency toward agglomeration and aggregation, and since they are difficult to separate mechanically, dispersion into the first binder in this way is difficult to achieve and results in sharp increases in viscosity. A remedy is provided, for example, by colloidally disperse, inorganic, amorphous silicon dioxide nanoparticles in solvents. In some embodiments, therefore, the slip and its at least one inorganic constituent comprise colloidally disperse, amorphous silicon dioxide nanoparticles, e.g., in the form of a colloid solution. A colloid solution of this kind may be stable with respect to agglomeration if the surface of the silicon oxide particles is covalently covered or “coated” with an epoxide-compatible adhesion promoter. In this way, even after stripping of the solvent, there is no coagulation or aggregation of the nanoscale filler particles.

In some embodiments, the slip comprises at least one further, high-temperature-resistant binder. This may produce particularly stable brown compacts. The high-temperature-resistant further binder may comprise sinterable silicone, e.g., condensation-crosslinking silicone solid. The sinterable silicone may be a powder in the slip, e.g., a nanoscale powder. Sinterable silicone dissolves well in methyl ethyl ketone, acetone, and/or isopropyl alcohol, and so relatively low solvent contents can be implemented for the adjustment of optimum flowabilities with dissolution of all binder constituents. This is a potential advantage of using the solvents methyl ethyl ketone, acetone and/or isopropyl alcohol.

The following compositions, for example, may form a slip:

TABLE 1

| | | Amount | Wt %, | |
|---|---|---|---|---|
| Material | Producer | [g] | solvent-free | Notes |
| Araldite | Huntsman | 5.79 | 8.0 | BADGE/ |
| LY 1564 | | | | BFDGE/RD |
| | | | | system |
| Aradur | Huntsman | 0.21 | 0.3 | preaccelerated |
| 3486 | | | | Jeffamin D-230 |
| HP-2000 | Wacker | 7.34 | 9.1 | amino- |
| | | | | methylphenyl- |
| | | | | silicone in 10% |
| | | | | toluene |
| Isopropyl | Baker | 5.50 | — | temporary |
| alcohol | | | | solvent; to be |
| | | | | stripped off |
| Sintered | n/a | 60.0 | 82.6 | trimodal, |
| powder | | | | amorphous |
| | | | | sintered |
| | | | | powder |

The composition shown in table 1, in addition to the amino-methylphenyl-silicone as silicone copolymer, comprises a small admixture of aminic hardener in the form of Jeffamin D-230. This aminosilicone-modified binder system produces a green compact density of 1.944 g/cm³ after 24 h at 35° C.

TABLE 2

| | | | Wt %, | |
|---|---|---|---|---|
| | | Amount | solvent- | |
| Material | Producer | [g] | free | Notes |
| Araldite | Huntsman | 5.14 | 7.1 | BADGE/ |
| LY 1564 | | | | BFDGE/RD |
| | | | | system |
| HP-2020 | Wacker | 7.46 | 10.0 | solvent-free |
| | | | | amino- |
| | | | | methylphenyl- |
| | | | | silicone |
| Isopropyl | Baker | 6.50 | — | temporary |
| alcohol | | | | solvent; to be |
| | | | | stripped off |
| Sintered | n/a | 60.0 | 82.6 | trimodal, |
| powder | | | | amorphous |
| | | | | sintered powder |

The aminosilicone-modified binder system described in table 2 differs from the composition shown in table 1 in the fact, among others, that Jeffamin D-230 is no longer used.

TABLE 3

| | | | Wt %, | |
|---|---|---|---|---|
| | | Amount | solvent- | |
| Material | Producer | [g] | free | Notes |
| HP-1250 | Wacker | 11.63 | 16.1 | solvent-free |
| | | | | glycidyloxy- |
| | | | | methylphenyl- |
| | | | | silicone |
| Aradur | Huntsman | 0.97 | 1.3 | preaccelerated |
| 3486 | | | | Jeffamin D-230 |
| HP-2000 | Wacker | 7.34 | 9.1 | amino- |
| | | | | methylphenyl- |
| | | | | silicone in 10% |
| | | | | toluene |
| Isopropyl | Merck | 6.50 | — | temporary solvent; |
| alcohol | | | | to be stripped off |
| Sintered | n/a | 60.0 | 82.6 | trimodal, |
| powder | | | | amorphous |
| | | | | sintered powder |

The glycidyloxysilicone-modified binder system described in table 3 differs from the composition shown in table 1 in that glycidyloxy-methylphenyl-silicone is now used in place of amino-methylphenyl-silicone. As a result there is no need for the BADGE/BFDGE/RD system, since the glycidyloxy-methylphenyl-silicone is epoxy-functional, meaning that it also has the property of an epoxy resin and/or its monomers and/or oligomers. Additionally, the glycidyloxy-methylphenyl-silicone exhibits the binding and possibly hardening quality of the silicone copolymer. To support the hardening, Jeffamin D-230 is admixed here.

Various components may include a casting mold, e.g., a casting core, for a metallic cast component, such as for a metal blade in gas turbines and propulsion turbines, for example. The casting core may include a multiwall casting core.

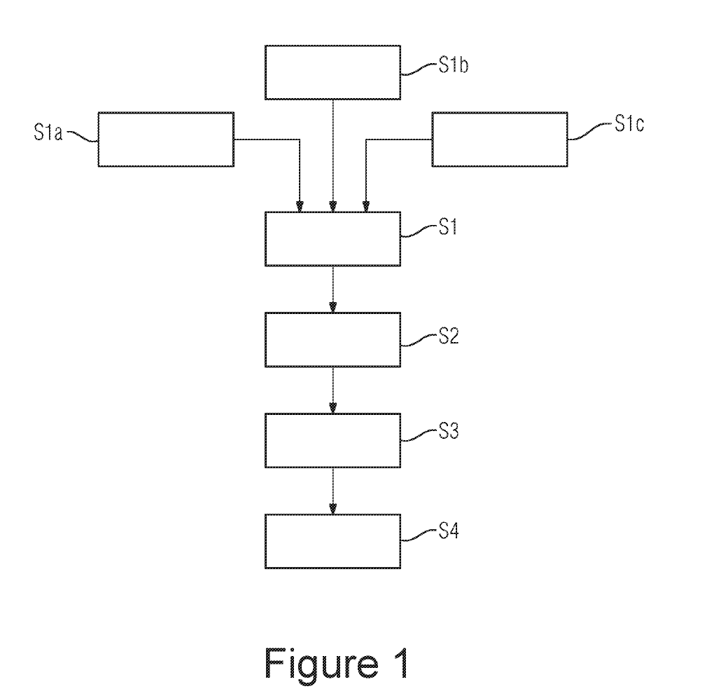

FIG. 1 shows an example method for producing a slip according to teachings of the present disclosure. For this purpose, in a first step S1, a slip based on ceramic powder is produced as per table 2.

In a first substep S1a, an amorphous powder mixture with a trimodal size distribution and composed of one or more ceramic powders is provided—for example, it comprises magnesium oxide, aluminum oxide, yttrium oxide, and zirconium oxide, (e.g., a fraction of 82.6 wt % (solvent-free)).

In a second substep S1b, a first binder component (e.g., epoxy base mixture) of a binder is provided, by a blend of BADGE and BFDGE with a mono- or difunctional, epoxidic reactive diluent RD. A mixture of this kind is available, commercially as “Araldite LY 1564” from Huntsman. In some embodiments, the binder component has a fraction of 7.1 wt % (solvent-free). In a third substep S1c, silicone copolymer is provided as a second binder component (hardener) of the binder, (e.g., solvent-free amino-methylphenyl-silicone with a fraction of 10.3 wt %).

By combining the starting materials provided in substeps S1a, S1b and S1c, with addition of isopropyl alcohol as solvent, the slip is produced in step S1. This combining may comprise a dispersing operation. Combining initiates a hardening process of the binder and hence also a solidification of the slip. The starting materials provided in substeps S1a, S1b and S1c may in principle be combined in any order.

In a subsequent shaping step S2, the slip is shaped or processed in its still-viscous state, e.g., processed layer by layer in alternation with template wax layers to form a green body.

In a subsequent hardening step S3, the binder hardens with retention of the template wax layers, e.g., at a temperature of not more than 35° C. At the end of the hardening step S3, the binder is fully hardened, and the shaped slip forms a green body with its geometry to be fixed by sintering later on. The green body is still coherent with the wax.

In the next step, a temperature treatment step S4, the green body is subjected to a heat treatment, the solvent having been stripped off beforehand by application of reduced pressure and/or vibration, for example.

In the course of the temperature treatment step S4, the wax first becomes fluid and runs off from the green body. Above about 250° C. to about 500° C., the binder undergoes pyrolysis, giving off volatile constituents as it does so, to form an amorphous quartz, which surrounds and thus fixes the sinterable ceramic powder. In a last temperature substep, the ceramic powder particles are sintered by high-temperature sintering, at between 850° C. and 1300° C., for example, more particularly to about 1200° C., to form a sintered ceramic body.

The sintered ceramic body may, for example, serve as a casting core or as a casting mold for subsequent precision metal casting.

Despite the embodiments having been described and illustrated in more detail by the working example shown, the teachings of the present disclosure are not confined to this example, and other variations can be derived from it by the skilled person without departing from the scope of the invention.

Generally speaking, “a”, “one”, etc., may be understood as a singular or a plural, more particularly in the sense of “at least one” or “one or more”, etc., unless such possibility is explicitly excluded, by the expression “precisely one”, etc., for example.

Moreover, a numerical figure may encompass precisely the number stated and also a customary tolerance range, unless that possibility is explicitly excluded.

Generally, in the context of the method, a mixing or combining may also comprise a provision of a previously mixed or combined formulation or composition, and vice versa. For example, the feature whereby “the binder is admixed with at least one epoxidic reactive diluent” may embrace the mixing of these constituents by a user of the method and also the utilization of a correspondingly preformulated composition by the user.

What is claimed is:

1. A method for producing a slip, the method comprising:
mixing at least one inorganic constituent with at least one binder;
wherein the binder comprises at least one epoxy resin and at least one silicone copolymer.

2. The method as claimed in claim 1, wherein said silicone copolymer comprises at least one glycidyl-functional poly(phenyl-methyl) silicone.

3. The method as claimed in claim 1, wherein said silicone copolymer comprises (S1c) at least one amino-functional poly(phenyl-methyl) silicone.

4. The method as claimed in claim 1, wherein the binder comprising a blend of the at least one silicone copolymer with bisphenol A diglycidyl ether and/or bispenol F diglycidyl ether.

5. The method as claimed in claim 1, wherein the binder comprises at least one amine.

6. The method as claimed in claim 5, wherein the additional hardener comprises at least one amine organo-substituted in beta position.

7. The method as claimed in claim 5, wherein the additional hardener comprises polyetheramine.

8. The method as claimed in claim 1, wherein the at least one epoxy resin comprises BADGE, BFDGE, or a blend thereof.

9. The method as claimed in claim 1, further comprising admixing the binder with at least one epoxidic reactive diluent.

10. The method as claimed in claim 1, further comprising admixing the binder with propylene carbonate, butylene carbonate, or glycerol carbonate.

11. The method as claimed in claim 1, further comprising admixing the slip with methyl ethyl ketone, acetone, or isopropanol as solvent.

12. The method as claimed in claim 1, wherein the at least one inorganic constituent comprises (Sla) different fractions having particle size distributions bimodal or multimodal to one another.

13. The method as claimed in claim 1, wherein the slip comprises colloidally disperse, amorphous silicon dioxide nanoparticles.

14. (canceled)

15. The method as claimed in claim 1, wherein the binder comprising a blend of the at least one silicone copolymer with bisphenol A diglycidyl ether and/or bispenol F diglycidyl ether, in a 10% to 50% (w/w) blend.

16. The method as claimed in claim 1, wherein the slip comprises colloidally disperse, amorphous silicon dioxide nanoparticles, and a surface of the silicon dioxide nanoparticles has been covalently coated with an epoxide-compatible adhesion promoter.

17. A method for producing a component, the method comprising:
mixing at least one inorganic constituent with at least one binder;
wherein the binder comprises at least one epoxy resin and at least one silicone copolymer;
using the mixture to form a slip; and
casting the component using the slip.
